(19) United States
(12) Patent Application Publication
(10) Pub. No.: US 2005/0286176 A1
(43) Pub. Date: Dec. 29, 2005

(54) Head gimbal assembly with flying height adjuster, disk drive unit and manufacturing method thereof

(75) Inventors: Ming Gao Yao, Dongguan City (CN); Masashi Shiraishi, Hong Kong (CN)

Correspondence Address: CROWELL & MORING LLP;INTELLECTUAL PROPERTY GROUP, P.O. BOX 14300, WASHINGTON, DC, 20044-4300, US

(73) Assignee: SAE Magnetics (H.K.) Ltd., Hong Kong (CN)

(21) Appl. No.: 10/873,163

(22) Filed: Jun. 23, 2004

(51) Int. Cl. G11B 5/56

(52) U.S. Cl. 360/294.4

(57) ABSTRACT

A head gimbal assembly (HGA) comprising a slider, a suspension to load the slider, and a flying height adjuster to adjust the flying height of the slider. The flying height adjuster has at least one thin film piezoelectric piece or ceramic piezoelectric piece, which is disposed between the slider and the suspension. The HGA may further include a micro-actuator to horizontally adjust the position of the slider. The micro-actuator is a pinched type micro-actuator or a metal frame type micro-actuator. The invention also discloses a disk drive unit having such HGA and a method of manufacturing the HGA.

### FIELD OF THE INVENTION

The present invention relates to a disk drive unit and manufacturing method thereof, and more particularly to a head gimbal assembly with flying height adjuster and manufacturing method thereof.

### BACKGROUND OF THE INVENTION

Disk drives are information storage devices that use magnetic media to store data. Referring to FIG. 1a and 1b, a typical disk drive in prior art has a magnetic disk 101, and a drive arm 104 to drive a head gimbal assembly (HGA, not labeled) with a slider 203 mounted thereon. The disk 101 is mounted on a spindle motor 102 which causes the disk 101 to spin and a voice-coil motor (VCM) 107 is provided for controlling the motion of the drive arm 104 and thus controlling the slider 203 to move from track to track across the surface of the disk 101 to read data from or write data to the disk 101.

However, Because of the inherent tolerance (dynamic play) resulting from VCM that exists in the displacement of the slider 203, the slider 203 can not attain a fine position course adjustment.

To solve the above-mentioned problem, piezoelectric (PZT) micro-actuators are now utilized to modify the displacement of the slider 203. That is, the PZT micro-actuator corrects the displacement of the slider 203 on a much smaller scale to compensate for the tolerance of the VCM 107 and the drive arm 104. It enables a smaller recording track width, increases the ‘tracks per inch’ (TPI) value by 50% of the disk drive unit, and also increases the surface recording density.

Referring to FIG. 1d, a traditional PZT micro-actuator 205 comprises a ceramic U-shaped frame 297 which comprises two ceramic beams 207 with two PZT pieces (not shown) on each side thereof. With reference to FIGS. 1c and 1d, the PZT micro-actuator 205 is physically coupled to a suspension 213, and there are three electrical connection balls 209 (gold ball bonding or solder ball bonding, GBB or SBB) to couple the micro-actuator 205 to the suspension traces 210 in one side of the ceramic beam 207. In addition, there are four metal balls 208 (GBB or SBB) to couple the slider 203 to the suspension 213 for electrical connection. FIG. 2 shows a detailed process of inserting the slider 203 into the micro-actuator 205. The slider 203 is bonded with the two ceramic beams 207 at two points 206 by epoxy dots 212 so as to make the motion of the slider 203 independent of the drive arm 104 (See FIG. 1a).

When power supply is applied through the suspension traces 210, the PZT micro-actuator 205 will expand or contract to cause the U-shaped frame 297 deform and then make the slider 203 move on the disk 101. Thus a fine position course adjustment can be attained.

However, the PZT micro-actuator 205 can only be used for the position course adjustment of a head gimbal assembly (HGA) 277 (see FIG. 1c), it cannot be used for flying height adjustment (FH adjustment) of the head gimbal assembly (HGA) 277. As is known to all, flying height is a very important parameter of disk drive. That is, if the flying height is too high, it will affect the slider 203 reading data from or writing data to the disk 101; on the contrary, if the flying height is too low, the slider 203 may scratch the disk 101 which will cause the damage of the slider 203 and/or the disk 101. In today's disk drive industry, with the rapid increase of disk drive's capacity, the track pitch and the track width of disk drive become increasing narrow, and the flying height of the slider 203 becomes increasingly low. As a consequence, a fine flying height adjustment for a HGA becomes ever more important. Hence, it is desired to provide a head gimbal assembly, disk drive and manufacturing method thereof which can attain both a fine flying height adjustment and a fine position course adjustment, and thus ensuring the slider 203 to read data from or write data to the disk 101 successfully and not to damage the slider 203 and/or the disk 101.

### SUMMARY OF THE INVENTION

A main feature of the present invention is to provide a head gimbal assembly, disk drive unit and manufacturing method thereof which can attain a fine flying height adjustment.

Another feature of the present invention is to provide a head gimbal assembly, disk drive unit and manufacturing method thereof which can attain both a fine flying height adjustment and a fine position course adjustment.

To achieve the above-mentioned feature, a head gimbal assembly comprises: a slider; a suspension to load the slider; and a flying height adjuster to adjust the flying height of the slider. In the present invention, the flying height adjuster has at least one thin film piezoelectric pieces or ceramic piezoelectric pieces. The flying height adjuster is disposed between the slider and the suspension. In an embodiment of the present invention, the head gimbal assembly further comprises a micro-actuator to horizontally adjust the position of the slider. The micro-actuator is a pinched type micro-actuator or a metal frame type micro-actuator. In the present invention, the micro-actuator has at least one thin film piezoelectric piece or ceramic piezoelectric piece.

In an embodiment of the present invention, the micro-actuator further comprises a support base to support the piezoelectric pieces. The flying height adjuster is positioned between the suspension and the support base. In another embodiment of the present invention, the flying height adjuster is positioned between the support base and the slider. The support base comprises a bottom plate, a top plate, and a leading beam to physically connect the bottom plate and the top plate. As an embodiment of the present invention, the support base may be a frame having two side beams and a bottom beam to connect the two side beams.

In an embodiment, the flying height adjuster has a plurality of bonding pads formed thereon. The suspension has a plurality of bonding pads thereon corresponding to the bonding pads on the flying height adjuster; the flying height adjuster is electrically connected with the suspension by electrically connecting the bonding pads of the flying height adjuster with the bonding pads of the suspension. In an embodiment, the bonding pads of the flying height adjuster are electrically connected with the bonding pads of the suspension by wire bonding.

A fabrication method of a head gimbal assembly comprises the steps of: forming a slider, a flying height adjuster and a suspension; positioning the flying height adjuster between the slider and the suspension; and coupling the flying height adjuster with the slider and the suspension. In the present invention, the flying height adjuster is made of thin film piezoelectric material or ceramic piezoelectric material. The method further comprises forming a micro-actuator to horizontally adjust the position of the slider. Forming the micro-actuator comprises the steps of: forming at least one piezoelectric pieces; forming a support base; and bonding the at least one piezoelectric pieces to the support base. As an embodiment, forming the support base comprises forming a bottom plate, a top plate, and a leading beam to physically connect the bottom plate and the top plate. As another embodiment, forming the support base comprises forming two side beams and a bottom beam to connect with the two side beams. In the present invention, forming the flying height adjuster comprises forming a plurality of bonding pads thereon. Forming the suspension comprises forming a plurality of bonding pads thereon corresponding to the bonding pads on the flying height adjuster. Coupling the flying height adjuster with the suspension comprises a step of electrically connecting the bonding pads of the flying height adjuster with the bonding pads of the suspension. In an embodiment, connecting the bonding pads of the flying height adjuster with the bonding pads of the suspension is performed by wire bonding.

A disk drive unit comprises an HGA; a drive arm to connect with the HGA; a disk; and a spindle motor to spin the disk. The HGA comprises a slider, a flying height adjuster to adjust the flying height of the slider, and a suspension. In the present invention, the flying height adjuster has at least one thin film piezoelectric piece or ceramic piezoelectric piece. The flying height adjuster is disposed between the slider and the suspension. The head gimbal assembly further comprises a micro-actuator to horizontally adjust the position of the slider.

Compared with the prior art, because the HGA of the present invention utilizes a flying height adjuster for flying height adjustment, so a fine flying height adjustment can be attained. In addition, the present invention can also utilize a flying height adjuster for flying height adjustment together with a micro-actuator for head course adjustment, to attain both a fine flying height adjustment and a fine position course adjustment. Accordingly, the TPI of the disk drive unit of the present invention can be greatly improved.

For the purpose of making the invention easier to understand, several particular embodiments thereof will now be described with reference to the appended drawings in which:

### DESCRIPTION OF THE DRAWINGS

FIG. 1a is a perspective view of a traditional disk drive;

FIG. 1b is an enlarged, partial view of FIG. 1a;

FIG. 1c is a perspective view of a HGA of prior art;

FIG. 1d is an enlarged, partial view of FIG. 1c;

FIG. 2 shows a detailed process of inserting a slider to a micro-actuator of the HGA in FIG. 1c;

FIG. 3 is a perspective view of a HGA according to a first embodiment of the present invention;

FIG. 4 is an enlarged, exploded partial perspective view of the HGA of FIG. 3 before its slider and micro-actuator unit are bonded with its suspension by metal balls;

FIG. 5 is an enlarged, partial perspective view of the assembled HGA of FIG. 3 before its slider and micro-actuator unit are bonded with its suspension by metal balls;

FIG. 6 is an enlarged, partial perspective view of the assembled HGA of FIG. 3 after its slider and micro-actuator unit are bonded with its suspension by metal balls;

FIG. 7 is a cross-sectional view of the HGA of FIG. 3 in the micro-actuator unit area;

FIG. 8 shows a micro-actuator unit of the HGA in FIG. 3 according to a first embodiment of the present invention;

FIG. 9 shows a process of assembling the micro-actuator unit in FIG. 8 and mounting the slider thereon;

FIG. 10a shows an electrical connection relationship of two side PZT pieces of the micro-actuator unit of FIG. 8, which have a same polarization direction according to an embodiment of the present invention;

FIG. 10b shows an electrical connection relationship of two side PZT pieces of the micro-actuator unit of FIG. 8, which have opposing polarization directions according to another embodiment of the present invention;

FIG. 10c shows two waveforms of voltages which are applied to the two side PZT pieces of FIG. 10a, respectively;

FIG. 10d shows a waveform of voltage which is applied to the two side PZT pieces of FIG. 10b, respectively;

FIGS. 10e and 10f show two different operation methods of the two side PZT pieces in FIG. 10a which causes the slider to move in a direction parallel to disk surface;

FIGS. 10g and 10h show two different polarization directions of a bottom PZT piece of the micro-actuator unit of FIG. 8 according to two embodiments of the present invention;

FIG. 10i shows a waveform of voltages which is applied to the bottom PZT piece of FIG. 10g or 10h;

FIG. 10j shows two operation methods of the bottom PZT piece in FIG. 10g or 10h which causes the slider to move in a direction vertical to disk surface;

FIG. 11 shows another assembly method of the micro-actuator unit of FIG. 8;

FIG. 12 is a partial perspective view of the HGA which has the assembled micro-actuator unit of FIG. 11;

FIG. 13 shows an electrical connection relationship between the micro-actuator unit of FIG. 11 and the suspension;

FIG. 14 is an exploded, perspective view of a micro-actuator unit according to a second embodiment of the present invention;

FIG. 15 is an perspective view to show the slider being mounted in a U-shaped frame of the micro-actuator unit of FIG. 14;

FIG. 16 is an exploded, partial perspective view of a HGA of the present invention which has the micro-actuator unit of FIG. 14;

FIG. 17 is an partial perspective view to show a bottom PZT piece of the micro-actuator unit of FIG. 14 being mounted on a suspension of the HGA of FIG. 16;

FIG. 18 is an partial perspective view of the assembled HGA of FIG. 16 after its slider and the micro-actuator unit of FIG. 14 are bonded with its suspension by metal balls;

FIG. 19a shows an electrical connection relationship of two side PZT pieces of the micro-actuator unit of FIG. 14, which have a same polarization direction according to an embodiment of the present invention;

FIG. 19b shows an electrical connection relationship of two side PZT pieces of the micro-actuator unit of FIG. 14, which have opposing polarization directions according to another embodiment of the present invention;

FIG. 19c shows two waveforms of voltages which are applied to the two side PZT pieces of FIG. 19a, respectively.

FIG. 19d shows a waveform of voltage which is applied to the two side PZT pieces of FIG. 19b, respectively.

FIGS. 19e and 19f show two different operation methods of the two side PZT pieces in FIG. 19a which causes the slider to move in a direction parallel to disk surface.

FIG. 19g show two operation methods of a bottom PZT piece of the micro-actuator unit of FIG. 14 which causes the slider to move in a direction vertical to disk surface;

FIG. 20 is a unitary perspective view of the HGA of FIG. 18 according to a second embodiment of the present invention.

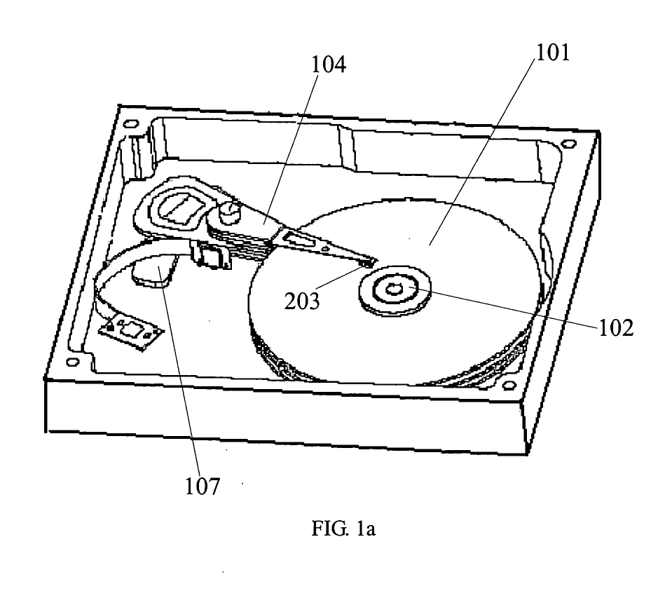

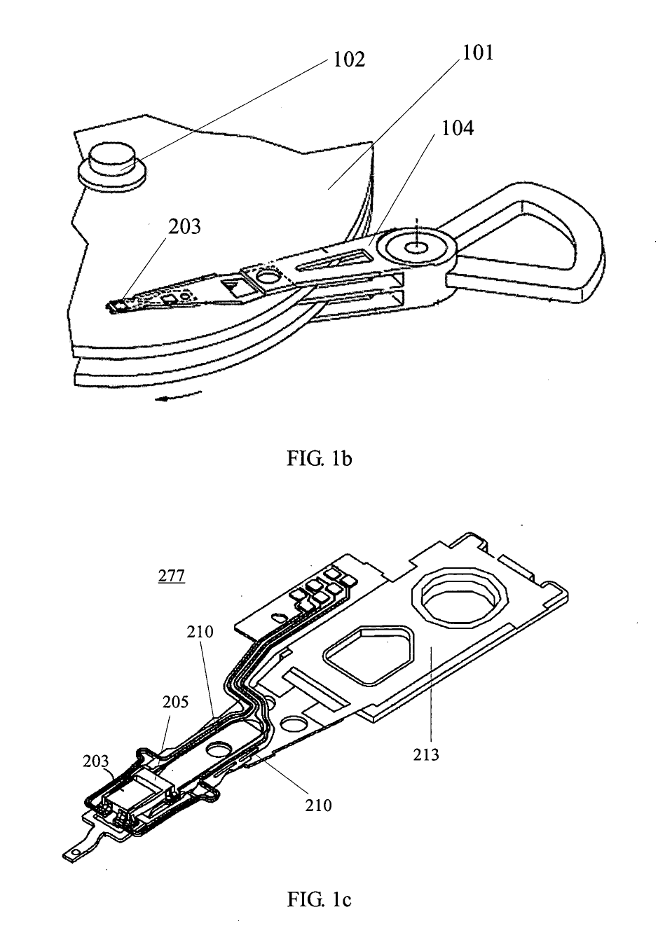

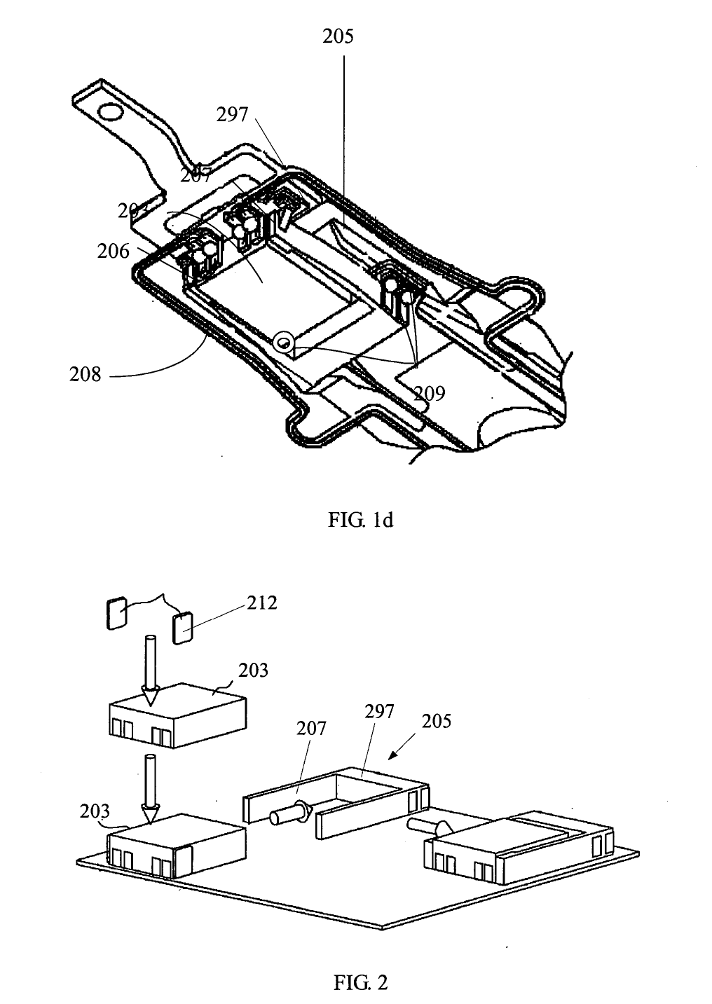

### DETAILED DESCRIPTION OF THE INVENTION

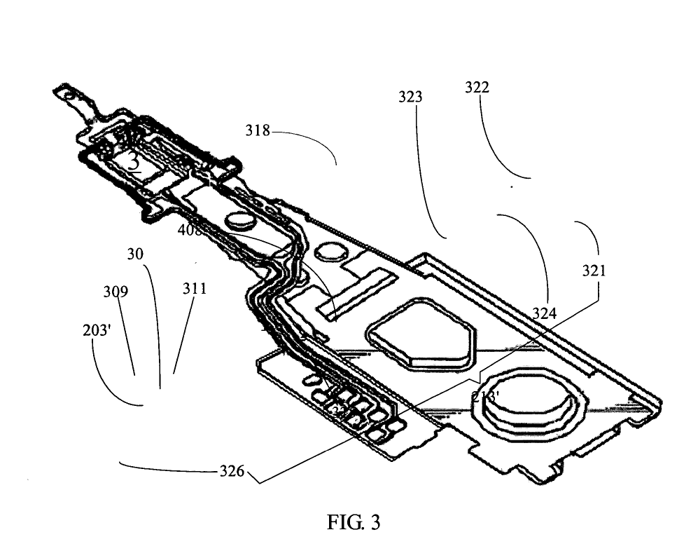

Referring to FIG. 3, a head gimbal assembly (HGA) 3 of the present invention comprises a slider 203′, a micro-actuator unit 30 and a suspension 213′ to load the slider 203′ and the micro-actuator unit 30.

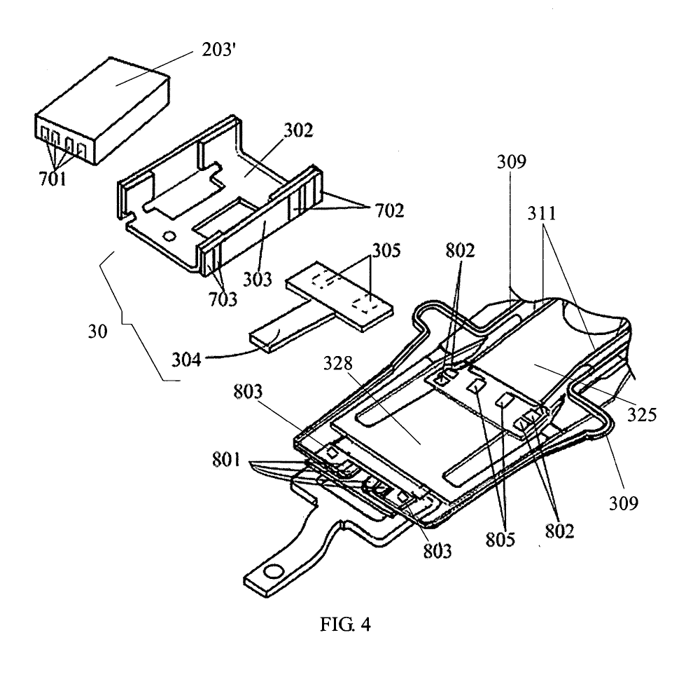

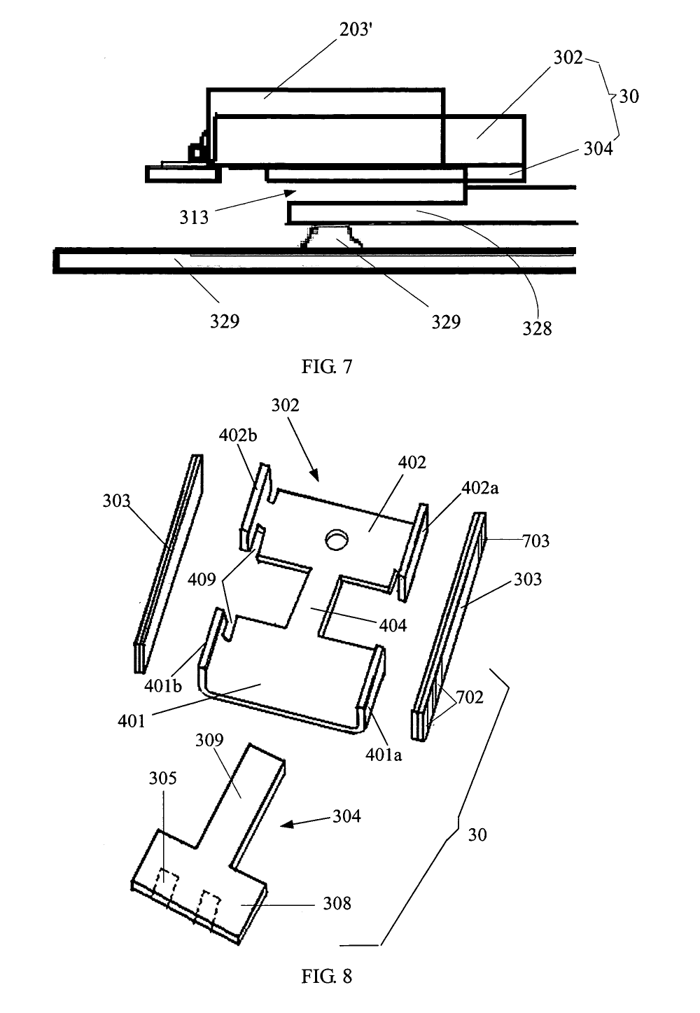

Also with reference to FIG. 3, the suspension 213′ comprises a load beam 326, a flexure 325, a hinge 324 and a base plate 321. The load beam 326 has three openings 408 formed therein as lamination datum hole and a plurality of dimples 329 (see FIG. 7) formed thereon as well. In the hinge 324 and the base plate 321 there formed two holes 322 and 323, respectively. The hole 322 is used for swaging the HGA 3 with the drive arm (not shown) and the hole 323 is used to reduce the weight of the suspension 213′. On the flexure 325 a plurality of connection pads 318 are provided to connect with a control system (not shown) at one end and a plurality of electrical multi-traces 309, 311 is provided in the other end. Referring to FIGS. 4 and 7, the flexure 325 also comprises a suspension tongue 328 which are used to support the micro-actuator unit 30 and keep the loading force always being applied to the center area of the slider 203′ through the dimples 329 of the load beam 326. The suspension tongue 328 has a plurality of electrical bonding pads 801, 802, 803, 805 formed thereon.

Referring to FIG. 8, the micro-actuator unit 30 comprises a micro-actuator (not labeled) and a flying height adjuster (not labeled). In the embodiment, the micro-actuator is a metal frame type micro-actuator, which comprises a metal support base 302 and a piezoelectric (PZT) unit comprising two side PZT pieces 303. The flying height adjuster is a bottom PZT piece 304 with two bonding pads 305 thereon. In the present invention, the support base 302 is preferably made of stainless steel. The support base 302 comprises a bottom plate 401, a top plate 402, and a leading beam 404 to physically connect the bottom plate 401 and the top plate 402. As an embodiment of the present invention, the bottom plate 401 forms two side beams 401a and 401b in its both sides and the top plate 402 forms two side beams 402a and 402b in its both sides as well. Additionally, each of the top plate 402 and the bottom plate 401 has two gaps 409 formed in a side thereof that connects with the leading beam 404. The gaps 409 can increase a moving length of the PZT unit and accordingly get a big displacement of the slider 203′. As an embodiment of the invention, the bottom PZT piece 304 is T-shaped and comprises a PZT base 308 and a PZT arm 309. The two bonding pads 305 are formed on the PZT base 308. Each of the side PZT pieces 303 forms three electrical bonding pads 702, 703 on both ends thereof. The side PZT pieces 303 and the bottom PZT piece 304 are preferably made of thin film PZT material which can be single layer structure or multi-layer structure. Also, the side PZT pieces 303 and the bottom PZT piece 304 can be made of ceramic PZT material.

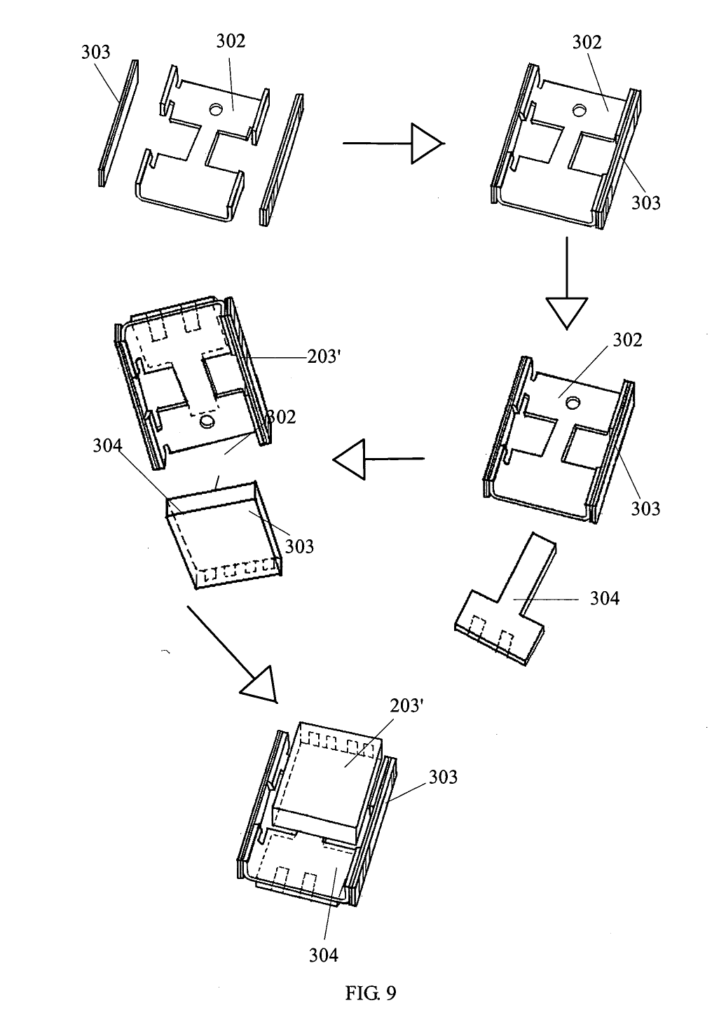

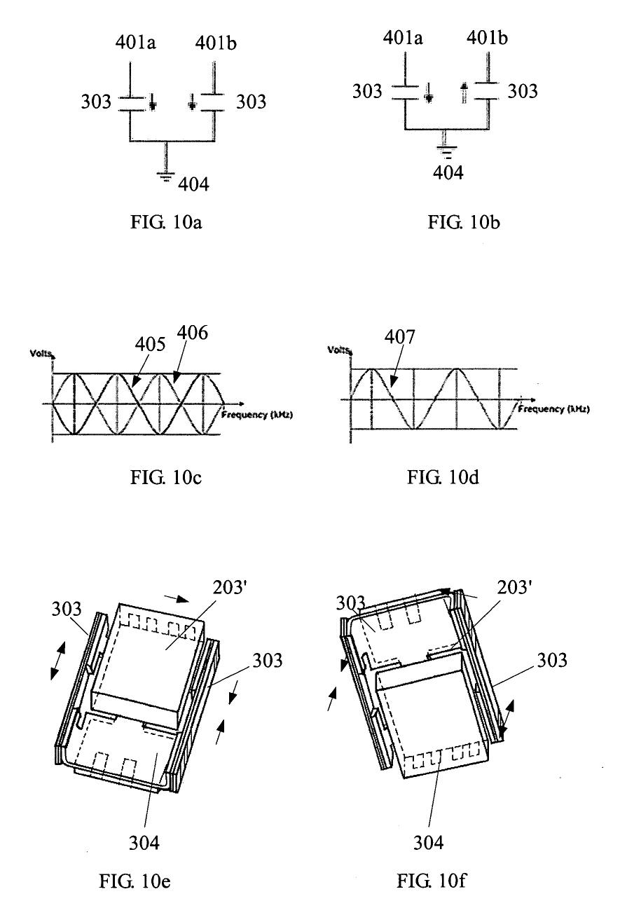

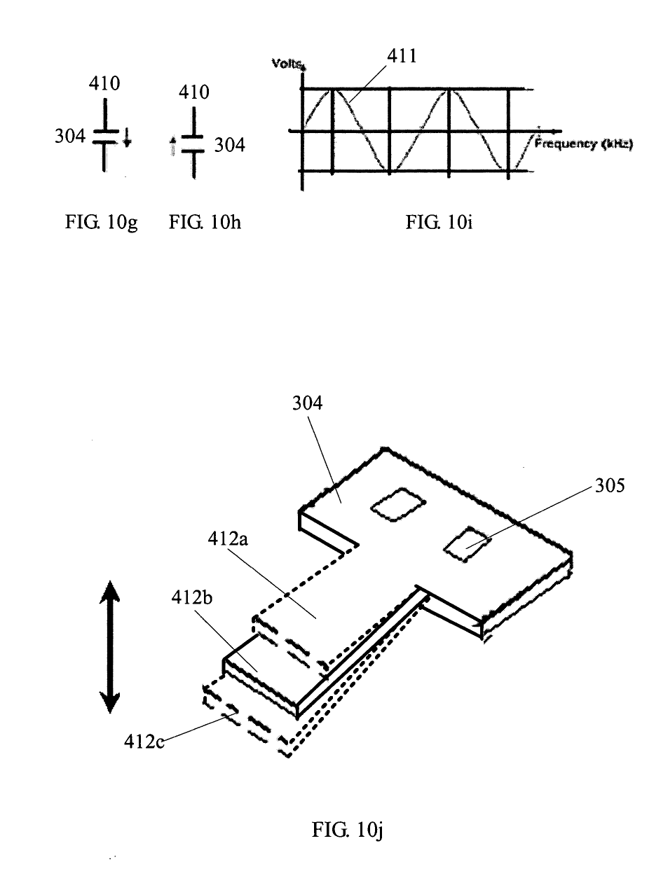

FIGS. 10a, 10c, 10e, and 10f show a first operation method of the two side PZT pieces 303 for performing position course adjustment function. In the embodiment, the two side PZT pieces 303 have a same polarization direction, as shown in FIG. 10a, which are commonly grounded by one end 404 and the other ends 401a and 401b thereof are applied two voltages with opposing phases of the waveforms 405 and 406, as shown in FIG. 10c. Referring to FIGS. 10e and 10f, under the drive of the voltages, one of the two side PZT pieces 303 will expand while the other contracts during the same half period. Once the voltages go to next half period, the two side PZT pieces 303 will change their phases and one of the two side PZT pieces 303 will contract while the other will expand. This will cause the slider 203′ to move in a direction parallel to disk surface and thus attain a head course adjustment.

FIGS. 10b and 10d show another operation method of the two side PZT pieces 303 for performing the position course adjustment function. In the embodiment, the two side PZT pieces 303 have two opposing polarization directions, as shown in FIG. 10b, which are also commonly grounded by one end 404, and the other ends 401a and 401b thereof are applied two voltages with a same waveform 407 (see FIG. 10d). Under the drive of the voltages, one of the two side PZT pieces 303 will expand while the other contracts during the same half period, and when the voltages go to next half period, one of the two side PZT pieces 303 will contract while the other expands. The slider 203′ is thus circularly moved from right side to left side and then returns from left side to right side.

FIGS. 10g and 10h show two different polarization directions which may be used by the bottom PZT piece 304. FIG. 10j shows two operation methods of the bottom PZT piece 304 for performing a FH adjustment function, the bottom PZT piece 304 is applied a voltage with a single waveform 411, as shown in FIG. 10i. Referring to FIG. 10j, when without being applied the voltage, the bottom PZT piece 304 will stay in its original position 412b; when a positive voltage is applied, the bottom PZT piece 304 will bend upward to a position 412a; when a negative voltage is applied, the bottom PZT piece 304 will bend downward to a position 412c. Thus the static pitch of the suspension will change and the static attitude of the slider 203′ will change together, and an FH adjustment of the slider 203′ can be achieved.

Referring to FIG. 9, forming a micro-actuator unit 30 comprises the steps of: firstly, providing a support base 302 and two side PZT pieces 303; then bonding the two side PZT pieces 303 to two sides of the support base 302; and finally, providing a bottom PZT piece 304 and bonding it with the support base 302. After that, a slider 203′ is provided and bonded to the support base 302 with the two side PZT pieces 303 and the bottom PZT piece 304 mounted thereon.

Referring to FIGS. 8 and 9, as an embodiment of the present invention, one of the two side PZT pieces 303 is bonded to the two side beams 401a and 402a of the support base 302, and the other is bonded to the two side beams 401b and 402b of the support base 302. The bottom PZT piece 304 is bonded to a backside of the support base 302 by coupling the PZT base 308 thereof to a backside of the bottom plate 401 by anisotropic conductive film (ACF), adhesive or epoxy. Accordingly the PZT arm 309 is positioned under the leading beam 404 of the support base 302 and the two bonding pads 305 of the PZT base 308 are exposed downwardly. In the present invention, one end of the slider 203′ is physically and electrically coupled with the top plate 402 by ACF, adhesive or epoxy, and the other end is positioned on the leading beam 404 of the support base 302. The physical coupling keeps the slider 203′ moving together with the micro-actuator unit 30 and the electrical coupling helps to prevent electro static discharge (ESD) damage of the slider 203′.

After the above assembly, referring to FIG. 5, the micro-actuator unit 30 with the slider 203′ is partially coupled with the suspension tongue 328 of the flexure 325 by anisotropic conductive film (ACF) and thus the bottom PZT piece 304 is sandwiched between the suspension tongue 328 and the support base 302 (see FIG. 7). Accordingly, the two bonding pads 305 of the bottom PZT piece 304 are electrically connected with the two bonding pads 805 and then electrically connected with the connection pads 318 through the electrical multi-traces 311. At the same time, a plurality of slider pads 701 of the slider 203′, the electrical bonding pads 702, 703 of the side PZT pieces 303 are positioned corresponding to the bonding pads 801, 802, and 803. Also, a parallel gap 313 is thus formed between the micro-actuator unit 30 and the suspension tongue 328 so as to ensure the smooth movement of the micro-actuator unit 30, best seen in FIG. 7.

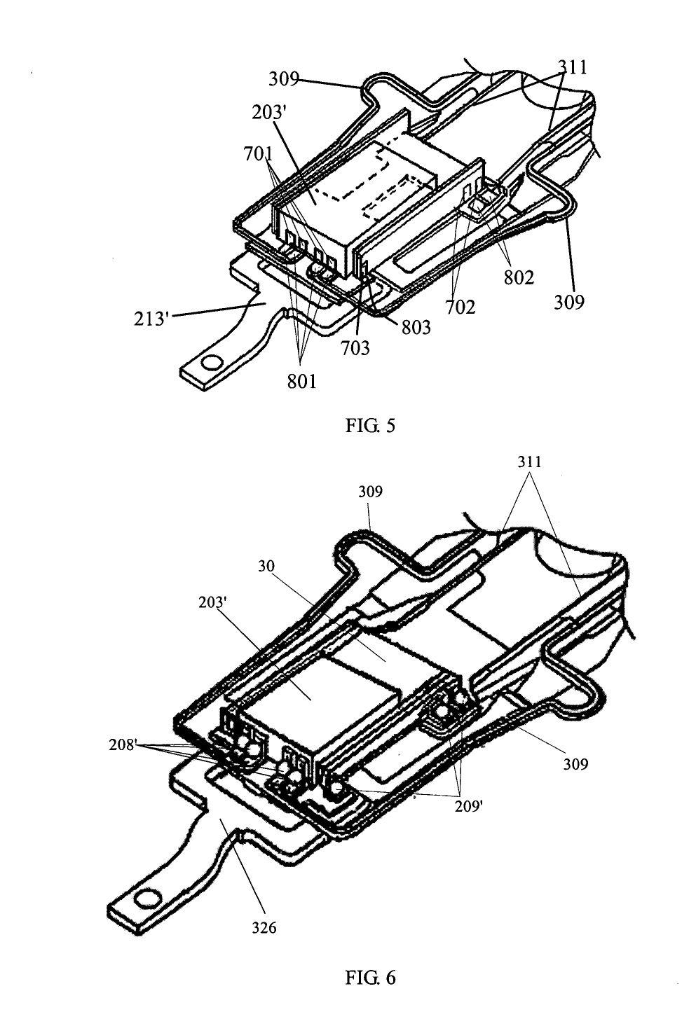

Referring to FIG. 6, in the present invention, four metal balls 208′ (GBB or SBB) are used to electrically connect the slider pads 701 with the bonding pads 801 so as to electrically connect the slider 203′ with the two electric multi-traces 309 of the suspension 213′. Simultaneously, three metal balls 209′ are used to electrically connect the bonding pads 702, 703 with the bonding pads 802 and 803 so as to electrically connect the micro-actuator unit 30 with the electric multi-traces 311. Through the electric multi-traces 309, 311, the connection pads 318 electrically connects the slider 203′ and the micro-actuator unit 30 with the control system (not shown).

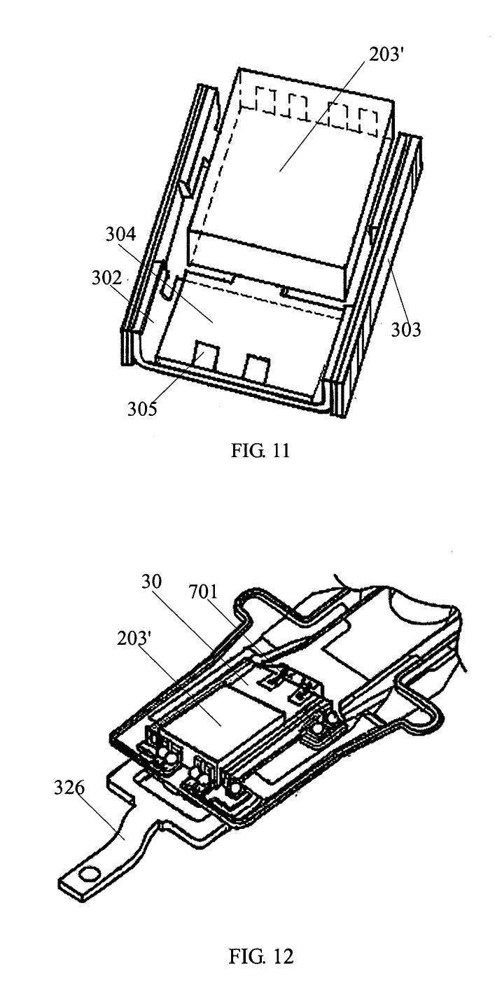

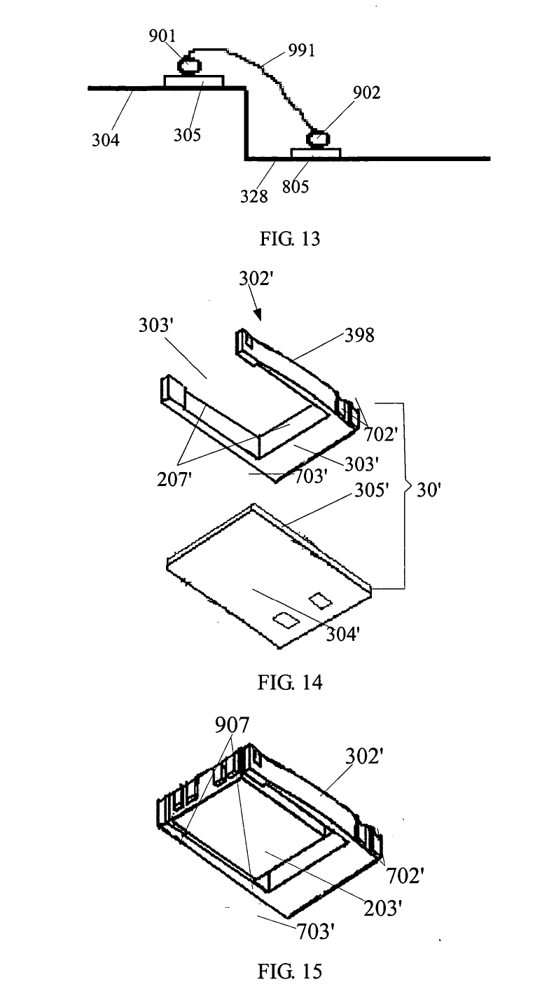

In another embodiment, referring to FIG. 11, the bottom PZT piece 304 can also be positioned between the slider 203′ and the support base 302 with the two bonding pads 305 being exposed upward. Subsequently, referring to FIG. 12, the bonding pads 305 of the bottom PZT piece 304 are electrically connected with the bonding pads 805 of the suspension tongue 328. Referring to FIG. 13, in an embodiment of the present invention, the electrical connection is performed as follows: bonding a metal ball 901 (such as using gold ball bonding, solder ball bonding, or laser welding) which is formed by melting a section of wire 991 output from a bonding device (not shown) in the bonding pad 305 of the bottom PZT piece 304 firstly, and then moving the bonding device to the bonding pad 805 of the suspension tongue 328 to form another metal ball 902 thereon without cutting off the wire 991. In the embodiment, no other change except the above-mentioned is happened on the structure and assembly of the HGA of the present invention. Therefore, a detailed description thereof is omitted herefrom.

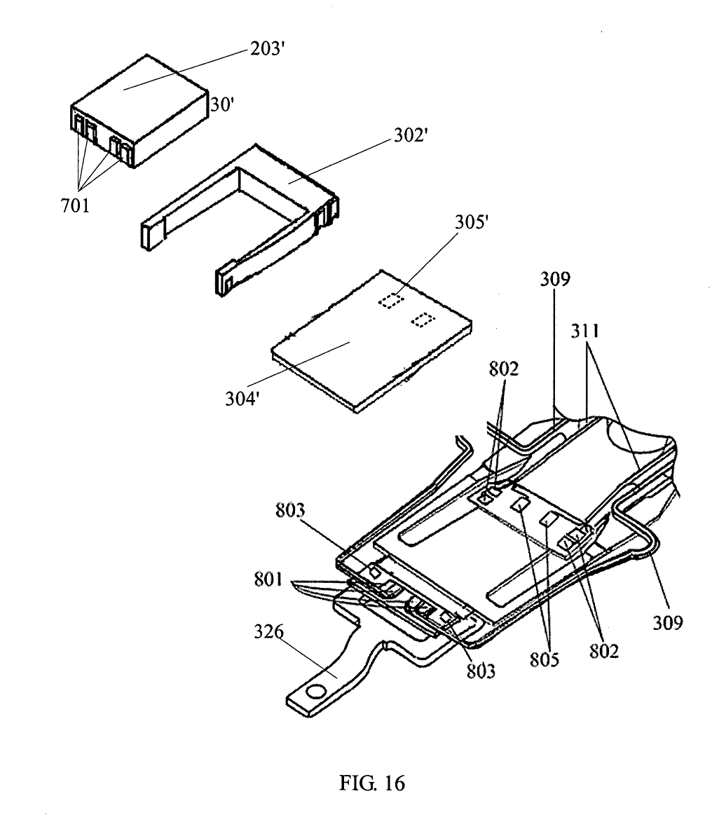

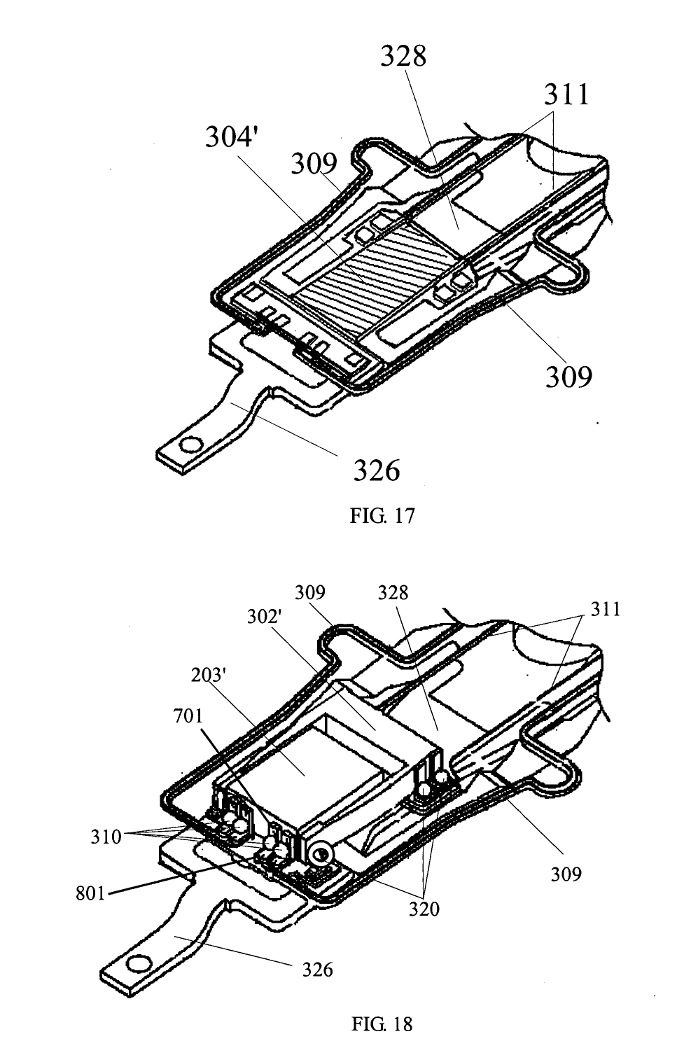

Referring to FIG. 14, a micro-actuator unit 30′ according to another embodiment of the present invention also comprises a micro-actuator (not labeled) and a flying height adjuster (not labeled). In the embodiment, the micro-actuator is a pinched type micro-actuator, which comprises a U-shaped frame 302′ and a piezoelectric (PZT) unit. The U-shaped frame 302′ comprises two side beams 207′ and a bottom beam 398 to connect with the two side beams 207′. In the present invention, the PZT unit comprises two side PZT pieces 303′ which are respectively bonded on the two side beams 207′ of the U-shaped frame 302′. In the embodiment, the flying height adjuster is a bottom PZT piece 304′ with two bonding pads 305′ thereon. As an embodiment of the invention, referring to FIGS. 16 and 17, the bottom PZT piece 304 is fully coupled with the suspension tongue 328 by ACF and accordingly the two bonding pads 305′ are bonded with the two bonding pads 805 of the suspension tongue 328. Each of the side PZT pieces 303′ forms three electrical bonding pads 702′, 703′ on both ends thereof. The bottom PZT piece 304′ is preferably made of thin film PZT which can be a single-layer structure or multi-layer structure. Also, the side PZT pieces 303′ and the bottom PZT piece 304′ can be made of ceramic PZT.

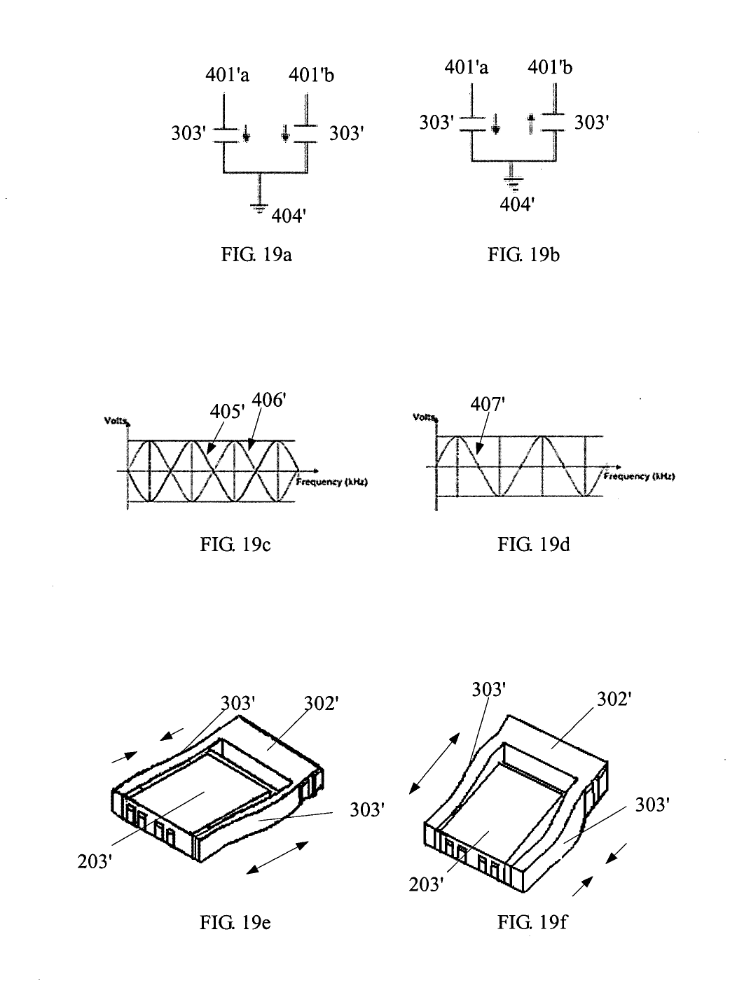

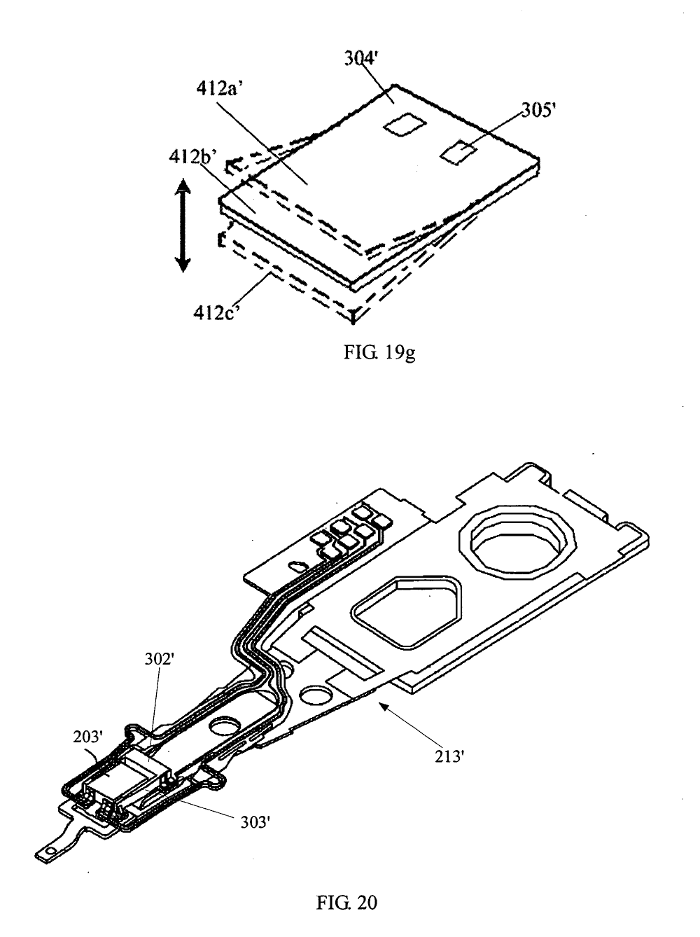

FIGS. 19a, 19c, 19e, and 19f show a first operation method of the two side PZT pieces 303′ for performing position course adjustment function. In the embodiment, the two side PZT pieces 303′ have the same polarization direction, as shown in FIG. 19a, which are commonly grounded by one end 404′ and the other ends 401′a and 401′b thereof are applied two voltages with opposing phases of the waveforms 405′ and 406′, as shown in FIG. 19c. Referring to FIGS. 19e and 19f, under the drive of the voltages, one of the two side PZT pieces 303′ will expand while the other contracts during the same half period. Once the voltages go to next half period, the two side PZT pieces 303′ will change their phases and one of the two side PZT pieces 303′ will contract while the other will expand. This will cause the slider 203′ to move in a direction parallel to disk surface and thus attain a head course adjustment.

FIGS. 19b and 19d show another operation method of the two side PZT pieces 303′ for performing the position course adjustment function. In one embodiment, the two side PZT pieces 303′ have two opposing polarization directions, as shown in FIG. 19b, which are also commonly grounded by one end 404; and the other ends 401′a and 401′b thereof are applied two voltages with the same waveform 407′ (see FIG. 19d). Under the drive of the voltages, one of the two side PZT pieces 303′ will expand while the other contracts during the same half period, and when the voltages go to next half period, one of the two side PZT pieces 303′ will contract while the other expands. The slider 203′ is thus circularly moved from right side to left side and then returns from left side to right side.

FIG. 19g shows two operation methods of the bottom PZT piece 304′ for performing an FH adjustment function, in the present invention, two different polarization directions can be selectively used by the bottom PZT piece 304′. In the present invention, the bottom PZT piece 304′ is applied a voltage with a single waveform, when without being applied the voltage, the bottom PZT piece 304′ will stay in its original position 412b′; when a positive voltage is applied, the bottom PZT piece 304′ will bend upward to a position 412a′; when a negative voltage is applied, the bottom PZT piece 304′ will bend downward to a position 412c′. Thus the slider 203′ will be driven to move up and down, and an FH adjustment of the slider 203′ can be achieved.

Referring to FIG. 16, forming a micro-actuator unit 30′ comprises the steps of: firstly, providing a U-shaped frame 302′ which has two side PZT pieces 303′; after that, providing a bottom PZT piece 304′ and bonding it with the suspension tongue 328, as shown in FIG. 17; and finally, a slider 203′ is provided and coupled with the side beams 207′ by two points 907, as shown in FIG. 15. Then the U-shaped frame 302′ with the slider 203′ are mounted on the suspension tongue 328 to sandwich the bottom PZT piece 304′ therebetween.

In the present invention, referring to FIGS. 14 and 16, the U-shaped frame 302′ with the slider 203′ are mounted on the suspension tongue 328 by partially bonding the bottom beam 398 of the U-shaped frame 302′ to the suspension tongue 328. Accordingly, the bonding pads 702′ and 703′ of the two side PZT pieces 303′ and the slider pads 701 are positioned corresponding to the bonding pads 802, 803 and 801 on the suspension tongue 328. Subsequently, referring to FIG. 18, four metal balls 310 (GBB or SBB) are used to electrically connects the slider pads 701 with the bonding pads 801 so as to electrically connect the slider 203′ with the two electric multi-traces 309 of the suspension 213′. Simultaneously, three metal balls 320 are used to electrically connect the bonding pads 702′, 703′ with the bonding pads 802 and 803 so as to electrically connect the micro-actuator unit 30′ with the electric multi-traces 311 and thus a HGA with the micro-actuator unit 30′ is formed, as shown in FIG. 20. Through the electric multi-traces 309, 311, the connection pads 318 electrically connects the slider 203′ and the micro-actuator unit 30′ with the control system (not shown).

When a working voltage is applied to the micro-actuator unit 30′, the two side PZT pieces 303′ will cause the slider 203′ to move in a direction parallel to disk surface so as to achieve a head course adjustment. At the same time, the bottom PZT piece 304′ will cause the slider 203′ to move in a direction vertical to disk surface and then achieve a FH adjustment.

A disk drive of the present invention can be attained by assembling a base plate, a disk, a spindle motor, a VCM with the HGA of the present invention. Because the structure and/or assembly process of a HGA and hard disk drive by using a micro-actuator unit, such as one according to the present invention are well known to persons ordinarily skilled in the art, a detailed description of such structure and assembly is omitted herefrom.

In the present invention, the micro-actuator unit may be replaced by a single PZT element (such as the bottom PZT piece 304 or 304′) used for flying height adjustment. The structure and manufacturing method of the HGA and disk drive unit with the single PZT element is easily actualized by persons ordinarily skilled in the art according to the above description of the HGA 3 and the corresponding disk drive unit and a detailed description thereof is omitted herefrom.

It is understood that the invention may be embodied in other forms without departing from the spirit thereof. Thus, the present examples and embodiments are to be considered in all respects as illustrative and not restrictive, and the invention is not to be limited to the details given herein.

1. A head gimbal assembly comprising:
a slider;
a suspension to load the slider; and
a flying height adjuster to adjust the flying height of the slider.

2. The head gimbal assembly as claimed in claim 1, wherein the flying height adjuster comprises at least one thin film piezoelectric piece or a ceramic piezoelectric piece.

3. The head gimbal assembly as claimed in claim 1, wherein the flying height adjuster is disposed between the slider and the suspension.

4. The head gimbal assembly as claimed in claim 1, wherein the head gimbal assembly further comprises a micro-actuator to horizontally adjust the position of the slider.

5. The head gimbal assembly as claimed in claim 4, wherein the micro-actuator comprises a pinched type micro-actuator or a metal frame type micro-actuator.

6. The head gimbal assembly as claimed in claim 4, wherein the micro-actuator comprises at least one thin film piezoelectric piece or a ceramic piezoelectric piece.

7. The head gimbal assembly as claimed in claim 6, wherein the micro-actuator further comprises a support base to support the piezoelectric piece.

8. The head gimbal assembly as claimed in claim 7, wherein the flying height adjuster is positioned between the suspension and the support base.

9. The head gimbal assembly as claimed in claim 7, wherein the flying height adjuster is positioned between the support base and the slider.

10. The head gimbal assembly as claimed in claim 7, wherein the support base comprises a bottom plate, a top plate, and a leading beam to physically connect the bottom plate and the top plate.

11. The head gimbal assembly as claimed in claim 7, wherein the support base comprises a frame consisting of two side beams and a bottom beam to connect the two side beams.

12. The head gimbal assembly as claimed in claim 1, wherein the flying height adjuster comprises a plurality of bonding pads formed thereon.

13. The head gimbal assembly as claimed in claim 12, wherein the suspension comprises a plurality of bonding pads thereon corresponding to the bonding pads on the flying height adjuster; the flying height adjuster is electrically connected with the suspension by electrically connecting the bonding pads of the flying height adjuster with the bonding pads of the suspension.

14. The head gimbal assembly as claimed in claim 13, wherein the bonding pads of the flying height adjuster are electrically connected with the bonding pads of the suspension by wire bonding.

15. A fabrication method of a head gimbal assembly comprising the steps of:
forming a slider, a flying height adjuster and a suspension;
positioning the flying height adjuster between the slider and the suspension; and
coupling the flying height adjuster with the slider and the suspension.

16. The fabrication method as claimed in claim 15, wherein the flying height adjuster is made of thin film piezoelectric material or ceramic piezoelectric material.

17. The fabrication method as claimed in claim 15, wherein the method further comprises forming a micro-actuator to horizontally adjust the position of the slider.

18. The fabrication method as claimed in claim 17, wherein forming the micro-actuator comprises the steps of:
forming at least one piezoelectric piece;
forming a support base; and
bonding the at least one piezoelectric piece to the support base.

19. The fabrication method as claimed in claim 18, wherein forming the support base comprises forming a bottom plate, a top plate, and a leading beam to physically connect the bottom plate and the top plate.

20. The fabrication method as claimed in claim 18, wherein forming the support base comprises forming two side beams and a bottom beam to connect with the two side beams.

21. The fabrication method as claimed in claim 15, forming the flying height adjuster comprises forming a plurality of bonding pads thereon.

22. The fabrication method as claimed in claim 21, wherein forming the suspension comprises forming a plurality of bonding pads thereon corresponding to the bonding pads on the flying height adjuster.

23. The fabrication method as claimed in claim 22, wherein coupling the flying height adjuster with the suspension comprises a step of electrically connecting the bonding pads of the flying height adjuster with the bonding pads of the suspension.

24. The fabrication method as claimed in claim 21, wherein connecting the bonding pads of the flying height adjuster with the bonding pads of the suspension is performed by wire bonding

25. A disk drive unit comprising:
a head gimbal assembly comprising:
a slider,
a flying height adjuster to adjust the flying height of the slider, and
a suspension;
a drive arm to connect with the head gimbal assembly;
a disk; and
a spindle motor to spin the disk.

26. The disk drive unit as claimed in claim 25, wherein the flying height adjuster comprises at least one thin film piezoelectric pieces or ceramic piezoelectric pieces.

27. The disk drive unit as claimed in claim 25, wherein the flying height adjuster is disposed between the slider and the suspension.

28. The disk drive unit as claimed in claim 25, wherein the head gimbal assembly further comprises a micro-actuator to horizontally adjust the position of the slider.
